(19) United States
(12) Patent Application Publication
(10) Pub. No.: US 2020/0378295 A1
(43) Pub. Date: Dec. 3, 2020

(54) COMPOSITE STRUCTURE, VEHICLE AND METHOD OF MANUFACTURING A COMPOSITE STRUCTURE

(71) Applicant: Faurecia Emissions Control Technologies, Germany GmbH, Augsburg (DE)

(72) Inventor: Juergen HERMANN, Augsburg (DE)

(21) Appl. No.: 16/884,255

(22) Filed: May 27, 2020

(30) Foreign Application Priority Data
May 31, 2019 (DE) 10 2019 114 665.8

(51) Int. Cl. F01N 13/14; B23K 1/00

(52) U.S. Cl. CPC F01N 13/148; B23K 2101/006; B23K 1/0008

(57) ABSTRACT

A composite structure comprises a cover plate and a plate-like fiber layer, one side of the plate-like fiber layer being fastened to one side of the cover plate with a solder at contact points of fibers of the plate-like fiber layer and the cover plate. Contacting fibers of the plate-like fiber layer are connected to each other with the solder in the plate-like fiber layer. A vehicle having a composite structure and a method of manufacturing a composite structure are furthermore disclosed.

### CROSS REFERENCE TO RELATED APPLICATIONS

This application is a U.S. non-provisional application claiming the benefit of German Application No. 10 2019 114 665.8, filed on May 31, 2019, which is incorporated herein by its entirety.

### TECHNICAL FIELD

The disclosure relates to a composite structure, to a vehicle having a composite structure, and to a method of manufacturing a composite structure.

### BACKGROUND

Composite structures are nowadays mainly used in lightweight construction, for example in vehicle construction, in order to create structures which are lightweight, durable, stiff, formable and temperature-resistant.

For this purpose, at least two structures, for example two plates, are non-detachably connected to each other. Typical examples of composite structures are sandwich and composite plates.

Such composite structures are used, for example, as a heat shield, as a cover and/or for insulation in a vehicle.

In the manufacture of composite structures, it is a particular challenge to create lightweight composite structures that are at the same time formable and stiff.

### SUMMARY

A composite structure is provided that is both easily formable and stiff.

A composite structure, in particular for an exhaust device of a vehicle, according to an exemplary aspect of the present disclosure includes, among other things, a cover plate and a plate-like fiber layer, one side of the plate-like fiber layer being fastened to one side of the cover plate with a solder only at contact point areas of fibers of the plate-like fiber layer and the cover plate. Contacting fibers of the plate-like fiber layer are connected to each other with the solder in the plate-like fiber layer in the entire thickness thereof only at contact points between fibers.

The disclosure is based on the basic idea that the composite structure is formed from a cover plate and a plate-like fiber layer. The plate-like fiber layer has several fibers, so that the plate-like fiber layer is a light layer and can be easily fastened to the cover plate. The plate-like fiber layer forms a light, and at the same time, an easily formable structure. In addition, a high stiffness is achieved in that contacting fibers of the plate-like fiber layer are connected to each other using the solder. As the connections via soldering are provided at contact points, i.e. at the contact point areas, only, the remaining portions of the fibers are remaining flexible. Further, there are numerous large, empty spaces between the fibers and between the fibers and the cover plate in the composite structure so that the weight and density of the composite structure are low. The attached fibers plus the attachment of the cover plate and the fibers are responsible for a high stability.

The fibers are preferably made of metal.

The plate-like fiber layer may be a warp knitted fabric, a weft knitted fabric or a braid. A stiff fiber layer is provided by the large number of linking points of the fibers with each other.

In order to provide a temperature resistant and durable plate-like fiber layer, the plate-like fiber layer may be made of a metal, in particular of a light metal.

Preferably, the plate-like fiber layer has a lower average density than the cover plate, so that the composite structure is lightweight.

For an accurate fastening of the plate-like fiber layer to the cover plate, the outer dimensions of the plate-like fiber layer and of the cover plate may be identical, preferably vary from each other by less than 20 mm in length and/or width.

In one configuration of the disclosure, the solder is a brazing solder. Brazing solders are temperature resistant so that the composite structure may also be used in areas having a high temperature, for example in the exhaust device of a vehicle. Furthermore, brazing solders have a high strength, which additionally stabilizes the plate-like fiber layer.

The plate-like fiber layer may have at least twice the thickness of the thickness of the cover plate. This reduces the weight of the composite structure.

In general, it is also conceivable that the plate-like layer has at least four times the thickness of the cover plate.

Additional stiffening structures are, for example, provided at the contact points to increase the stiffness of the composite structure.

Examples of stiffening structures are plates, rings, hooks and/or folded areas of the cover plate. In this way, the composite structure may be additionally reinforced in areas that are at risk of erosion.

In order to improve the fastening of the plate-like fiber layer to the cover plate, the plate-like fiber layer and the cover plate may also be fastened to each other by spot welding at least at one contact point.

In one configuration of the disclosure, the composite structure comprises a further cover plate, an opposite side of the plate-like fiber layer being fastened to one side of the further cover plate only at contact point areas with a solder. The plate-like fiber layer may thus be used to connect two plates to each other. The composite structure may of course have more than two plate-like fiber layers and more than three cover plates.

The plate-like fiber layer is preferably arranged between the two cover plates. This provides a sandwich composite structure which is significantly lighter and less expensive than comparable full metal structures, as less material is used.

Generally, this construction may be continued as desired, so that a third cover plate and a second plate-like fiber layer may be provided, each plate-like fiber layer being respectively arranged between two cover plates. The layered design of the composite structure permits a simple adaptation of the composite structure to the intended use.

A vehicle, in particular a motor vehicle, according to an exemplary aspect of the present disclosure includes, among other things, a composite structure according to the disclosure. With regard to the advantages and features, reference is made to the above explanations as to the composite structure according to the disclosure, which apply equally to the vehicle.

Furthermore, A method of manufacturing a composite structure, in particular a composite structure of an exhaust device of a vehicle, according to an exemplary aspect of the present disclosure includes, among other things, the following steps:
a) providing a cover plate and a plate-like fiber layer,
b) applying a solder to a fastening side of the plate-like fiber layer and/or of the cover plate,
c) placing the cover plate and the plate-like fiber layer one on top of the other, the fastening sides thereof facing each other and the cover plate resting on the plate-like fiber layer at contact points, and
d) heating the cover plate and the plate-like fiber layer such that the plate-like fiber layer and the cover plate are brazed only at contact point areas, solder being present over an entire thickness of the plate-like fiber layer during heating and contacting fibers of the plate-like fiber layer being brazed only at their contact point areas.

The method is based on the basic idea that both the plate-like fiber layer and the cover plate are first produced separately and are then firmly connected to each other with a solder locally at contact point areas. For this purpose, the solder is applied onto a fastening side of the plate-like fiber layer and/or of a cover plate, and the plate-like fiber layer and the cover plate are positioned relative to each other. The sides to which solder has been applied touch each other at the contact points. Due to the heating of the cover plate and of the plate-like fiber layer, the solder melts, and after cooling of the composite structure, contacting fibers of the plate-like fiber layer are connected to each other and the plate-like fiber layer and the cover plate are connected to each other only at the contact point areas. Thus, prior to the brazing process, the plate-like fiber layer is well formable and can be adapted to the cover plate, and after the brazing process, the stiffness of the plate-like fiber layer is increased due to the connection of contacting fibers of the plate-like fiber layer.

In order to position the plate-like fiber layer and the cover plate relative to each other, the cover plate can be fastened to the plate-like fiber layer at least at one contact point by spot-welding prior to the brazing process.

Alternatively or additionally, the cover plate and the plate-like fiber layer can be positioned relative to each other using a template during the brazing.

In one configuration of the disclosure, the cover plate and the plate-like fiber layer are brazed in a protective atmosphere furnace or in a vacuum furnace. This improves the brazed joint, as the penetration of foreign bodies or of oxides is not possible.

It may be provided that the method comprises the following further steps:
providing a further cover plate in step a),
applying a solder onto a fastening side of the further cover plate and/or of the plate-like fiber layer in step b),
placing the plate-like fiber layer and the further cover plate one on top of each other in step c), and
heating the further cover plate and the plate-like fiber layer provided between the cover plate and the further cover plate in step d).

The composite structure is thus made up in layers and may be extended as desired. The composite structure may thus easily be adapted to specific requirements, for example to insulation requirements.

In particular, it may be provided that further cover plates and further plate-like fiber layers are provided.

In order to enable a precise application of the solder, the solder may be applied as a brazing paste.

It is in principle possible that the solder is applied onto the cover plate and/or the plate-like fiber layer
e) by spraying or dipping,
f) is applied as a foil onto the cover plate and/or the plate-like fiber layer, and/or
g) is applied and the fibers are solder-coated during manufacture of the plate-like fiber layer.

In order to connect contacting fibers, there may be so much solder in a contact area (which is not limited to the contact point area) between the cover plate and the plate-like fiber layer before heating that the solder passes through the plate-like fiber layer upon melting to braze the fibers at the contact points. Alternatively, the fibers may be inherently solder-coated such that when heated, this solder melts just like the solder between the cover plate and the plate-like fiber layer.

It may be provided that the composite structure described above has been manufactured using the method described above.

### BRIEF DESCRIPTION OF THE DRAWINGS

Further advantages and features of the disclosure will become apparent from the following description of various embodiments and from the attached drawings to which reference is made below. In the drawings:

FIG. 1 shows a schematic side view of a vehicle according to the disclosure having a composite structure according to the disclosure,

FIG. 2 shows a schematic longitudinal sectional view of the composite structure of FIG. 1,

FIG. 3 shows a detailed view of detail A of FIG. 2,

FIGS. 4 and 5 each show a schematic side view of contacting fibers of the fiber layer of FIG. 2,

FIG. 6 shows a second embodiment of a composite structure according to the disclosure in a longitudinal section, and

FIG. 7 shows a schematic block diagram showing the method according to the disclosure.

### DETAILED DESCRIPTION

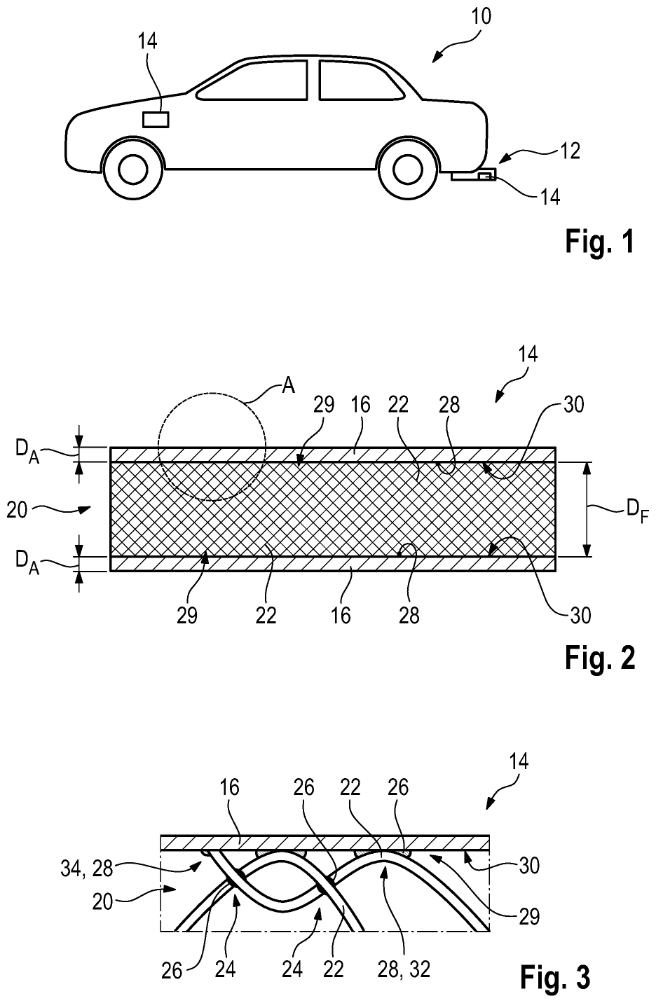

FIG. 1 shows a schematic side view of a vehicle 10, here a motor vehicle, having an exhaust device 12, here having an exhaust.

Both the vehicle 10 and the exhaust device 12 have a composite structure 14 in FIG. 1.

FIG. 2 shows a schematic longitudinal section through the composite structure 14 of FIG. 1.

The composite structure 14 comprises at least two cover plates 16 and at least one fiber layer 20.

Due to the arrangement of the plates in FIG. 2, reference will be made to an upper cover plate 16 and to a lower cover plate 16 in the following. This is only for better understanding and has nothing to do with the positioning of the cover plates 16 relative to each other.

The cover plates 16 are plates having a length, a width and a thickness D_{A}.

The thickness D_{A} of the upper cover plate 16 is equal to the thickness D_{A} of the lower cover plate 16. Generally, the upper and lower cover plates 16 may also have different thicknesses D_{A}.

The fiber layer 20 is formed in a plate-like manner, i.e. it has a length, a width and a thickness D_{F}.

In the embodiment of the composite structure 14 shown in FIG. 2, the thickness D_{F} of the fiber layer 20 is approximately six times the thickness D_{A} of the cover plates 16.

Generally, it is conceivable that the thickness D_{F} of the fiber layer 20 is at least twice or at least four times the thickness D_{A} of the cover plates 16.

The fiber layer 20 includes a large number of fibers 22 which are interconnected and form the fiber layer 20. For the sake of clarity, only two fibers 22 are marked with reference numbers in the figure.

In the embodiment of FIG. 2, the fibers 22 are entwined around each other. This is shown more precisely in the detailed view of FIG. 3, which shows detail A of FIG. 2.

FIG. 3 shows two entwining fibers 22 which touch each other at two linking points 24.

The fiber layer 20 is accordingly a warp knitted fabric in which the fibers form 22 meshes which engage each other. Due to the engagement of the fibers 22, the fiber layer 20 is dimensionally stable.

Generally, it is also conceivable that the fiber layer 20 is a weft knitted fabric or a braid.

In order to give the fiber layer 20 more stability, the individual fibers 22 of the fiber layer 20 are connected at the linking points 24 with a solder 26. These linking points define contact point areas.

More precisely, contacting fibers 22 of the fiber layer 20 are connected to each other with the solder 26.

The solder 26 is, for example, a brazing solder.

The fiber layer 20 is arranged between the upper cover plate 16 and the lower cover plate 16.

The upper cover plate 16 is in contact with the fiber layer 20 at contact point areas 28 which surround the single contact point. The same applies to the fiber layer 20 and the lower cover plate 16. For the sake of clarity, only two contact point areas 28 are marked with the appropriate reference numbers in FIG. 2.

More precisely, the fibers 22 on two fastening sides 29 of the fiber layer 20 are in direct contact with a respective fastening side 30 of the upper and lower cover plate 16 at the contact points. The fastening sides 29 of the fiber layer 20 and the fastening sides 30 of the cover plates 16 face each other.

FIG. 3 shows that there are large and multiple hollow, solder-free spaces between fibers and fibers and the cover plates where neither solder nor fibers are provided. Thus, the composite structure is mainly defined by small hollow chambers connected to each other.

The fastening sides 29 of the fiber layer 20 are arranged opposite each other.

In order to connect the cover plates 16 to the fiber layer 20, the fibers 22 are fastened only in the contact point areas 28 to the respective fastening side 30 of the cover plates 16.

In the detailed view of FIG. 3, a fiber 22 is fastened to the fastening side 30 of the cover plate 16 only at a contact point area 28 with the solder 26, such that this contact point area 28 is a brazing point 32.

Preferably, the fiber 22 is fastened at a further contact point area 28 to the fastening side 30 by spot welding. This contact point area 28 is therefore a weld point 34.

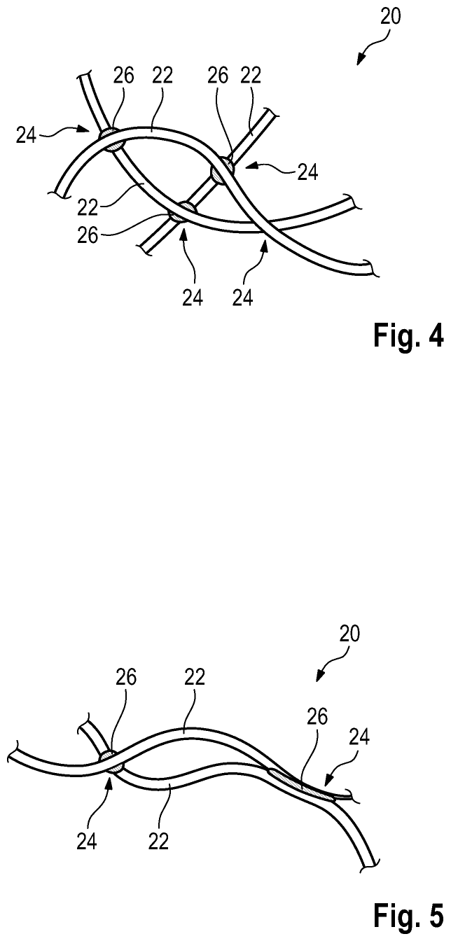

FIGS. 4 and 5 show, by way of example, contacting fibers 22 of the fiber layer 20 in a schematic side view.

FIG. 4 shows a detail of the fiber layer 20 in which the fibers 22 are firmly connected to each other essentially at all linking points.

Fibers 22 are shown which touch each other at the linking points 24. However, there is no solder 26 at one of the linking points 24, so that the fibers 22 are firmly connected to each other only at the other linking points 24.

FIG. 5 shows that the fibers 22 may also touch each other over a larger area (see linking point 24 on the right-hand side of FIG. 5) and may be connected to each other over the entire contact point area with the solder 26.

FIG. 6 shows a second embodiment of the composite structure 14 in the schematic longitudinal section of FIG. 2.

The second embodiment of the composite structure 14 essentially corresponds to the first embodiment, so that only the differences are discussed below. Identical and functionally identical components are marked with the same reference numbers.

FIG. 6 shows a composite structure 14 having three cover plates 16 and two fiber layers 20, with each fiber layer 20 being respectively arranged between two cover plates 16.

The middle cover plate 16 thus has two fastening sides 30 which are arranged opposite each other.

In contrast to the embodiment of FIG. 2, the cover plates 16 do not all have the same thickness D_{A}. In the embodiment shown, the middle cover plate 16 has a greater thickness D_{A} than the other two cover plates 16.

In addition, stiffening structures increasing the stiffness of the fiber layer 20 are arranged in the fiber layer 20.

Generally, it is conceivable to use rings, hooks, plates and/or folded areas as stiffening structures and to connect them to the fiber layers 20 and/or to the cover plates 16.

In the first and second embodiment of the composite structure 14, both the fiber layers 20 and the cover plates 16 are made of a metal, in particular a light metal.

Both the fibers 22 and the cover plates 16 are, for example, made of aluminum.

The different features of the two embodiment may of course be combined with each other as desired. In particular, the features listed as differences to the second embodiment are independent and may also be present in the first embodiment in different ways.

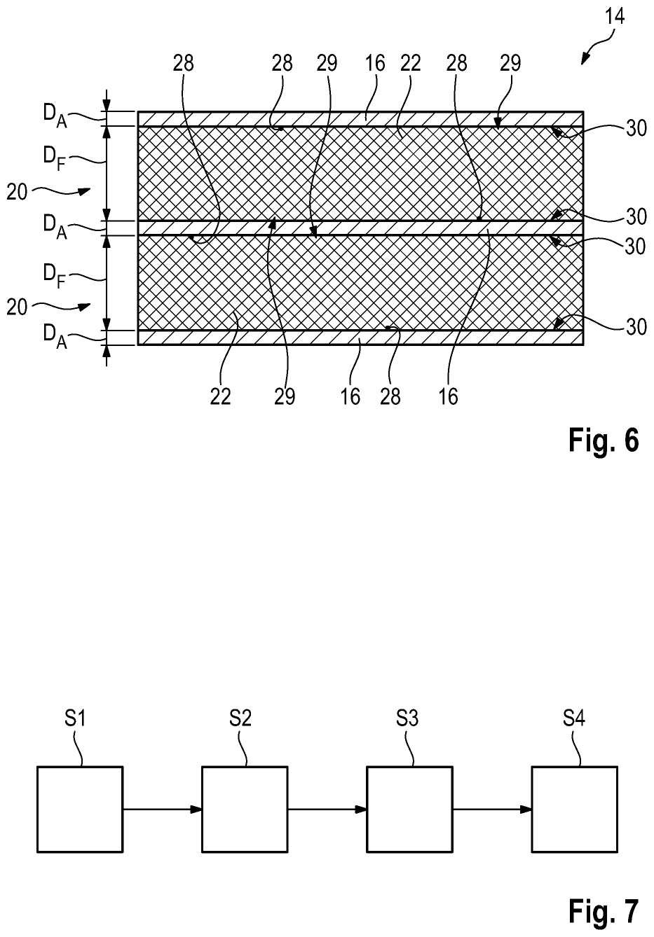

The method of manufacturing the composite structure 14 will be explained below with reference to FIGS. 6 and 7. FIG. 7 shows the different steps (S1 to S4) of the method in a block diagram.

In a first method step S1, the cover plates 16 and the fiber layers 20 are provided.

The fiber layers 20 may, for example, be manufactured using solder-coated fibers 22.

In the next method step S2, the solder 26 is applied onto the fastening side 29 of the fiber layer 20 and/or the fastening side 30 of the cover plates 16.

To this end, it is, for example, possible to arrange a solder foil between the fiber layers 20 and the cover plates 16.

It is also conceivable to apply a solder paste onto the fastening sides 30 of the cover plates 16 and/or the fastening sides 29 of the fiber layers 20.

Alternatively or additionally, the solder 26 may also be sprayed thereon, so that the solder 26, for example, passes through the fiber layers 20 and wets the fibers 22 with solder 26 over the entire thickness D_{F} of the fiber layers 20.

It is also possible to dip the fiber layers 20 into the solder 26 to achieve penetration of the fiber layer 20 by the solder 26.

In the next method step S3, the cover plates 16 and the fiber layers 20 are placed one on top of the other so that each fiber layer 20 is respectively arranged between two cover plates 16. The fastening sides 29 of the fiber layers 20 and the fastening sides 30 of the cover plates 16 face each other, and the cover plates 16 rest on the fiber layers 20 at the contact point areas 28 (see FIG. 7).

In this method step, the individual layers of the composite structure 14 may be held together using a template, and/or the fiber layers 20 and the cover plates 16 may be fastened to each other by spot welding at least at one contact point area 28 (see weld point 34 in FIG. 3). This prevents the cover plates 16 and the fiber layers 20 from moving relative to each other.

Subsequently, i.e. in method step S4, the cover plates 16 and the fiber layers 20 are heated together in a furnace. The furnace has a protective atmosphere and/or is under vacuum.

When heated in the furnace, the solder 26 melts and wets contacting fibers 22 of the fiber layers 20 and the fiber layers 20 and the cover plates 16 at the contact points 28. It is important that the fibers 22 are brazed together over the entire thickness, i.e. that not only fibers near the cover plate 22 are brazed together.

After cooling of the composite structure 14, contacting fibers 22 of the fiber layer 20 are then connected to each other, and the fiber layers 20 are connected to the cover plates 16.

If sufficient solder 26 has been applied between the cover plate 16 and the fiber layer 20 (in method step S2), the liquid solder 26 can pass through the fiber layer 20 and thus connect contacting fibers 22 of the fiber layer 20.

The method described above was directed to the manufacture of the composite structure 14 in the second embodiment. The method may of course be applied in the same way to a composite structure having one fiber layer 20 and one cover plate 16 or having one fiber layer 20 and two cover plates 16.

The method may of course also be used for composite structures 14 having more than two fiber layers 20 and more than three cover plates 16.

The fact that the connection between adjacent fibers and between fibers and the at least one cover plate leads to an extremely high number of hollow, solder-free spaces between the fibers and between fibers and the cover plate(s). Thus, the solder does not define an own, thick continuous layer which extends parallel to one of the cover plates in which layer the fibers are simply embedded. This design would not limit the connection between fibers and between fibers and the at least one cover plate to the connection point areas only.

Although various embodiments have been disclosed, a worker of ordinary skill in this art would recognize that certain modifications would come within the scope of this disclosure. For that reason, the following claims should be studied to determine the true scope and content of this disclosure.

1. A composite structure, in particular for an exhaust device of a vehicle, comprising:
a cover plate and a plate-like fiber layer, one side of the plate-like fiber layer being fastened to one side of the cover plate with a solder only at contact point areas of fibers of the plate-like fiber layer and the cover plate, and contacting fibers of the plate-like fiber layer being connected to each other with the solder in the plate-like fiber layer in an entire thickness thereof only at contact point areas of the fibers.

2. The composite structure according to claim 1, wherein the solder is a brazing solder.

3. The composite structure according to claim 1, wherein the plate-like fiber layer has at least twice the thickness of a thickness of the cover plate.

4. The composite structure according to claim 1, wherein the composite structure comprises a further cover plate, an opposite side of the plate-like fiber layer being fastened to one side of the further cover plate only at contact points with solder.

5. The composite structure according to claim 4, wherein the plate-like fiber layer is arranged between the cover plate and the further cover plate.

6. A vehicle, in particular a motor vehicle, having a composite structure according to claim 1.

7. A method of manufacturing a composite structure, in particular a composite structure of an exhaust device of a vehicle, includes the following steps:
a) providing a cover plate and a plate-like fiber layer,
b) applying a solder to a fastening side of the plate-like fiber layer and/or of the cover plate,
c) placing the cover plate and the plate-like fiber layer one on top of the other, the fastening sides thereof facing each other and the cover plate resting on the plate-like fiber layer at contact points, and
d) heating the cover plate and the plate-like fiber layer such that the plate-like fiber layer and the cover plate are brazed only at contact point areas, solder being present over an entire thickness of the plate-like fiber layer during heating, and contacting fibers of the plate-like fiber layer being brazed only at contact point areas of the contacting fibers.

8. The method according to claim 7, wherein the cover plate is fastened to the plate-like fiber layer by spot welding at least at one contact point before brazing.

9. The method according to claim 7, wherein the cover plate and the plate-like fiber layer are positioned relative to each other via a template during brazing.

10. The method according to claim 7, wherein the cover plate and the plate-like fiber layer are brazed in a protective atmosphere furnace or in a vacuum furnace.

11. The method according to claim 7, wherein the method comprises the following further steps:
providing a further cover plate in step a),
applying a solder onto a fastening side of the further cover plate and/or of the plate-like fiber layer in step b),
placing the plate-like fiber layer and the further cover plate one on top of each other in step c), and
heating the further cover plate and the plate-like fiber layer provided between the cover plate and the further cover plate in step d).

12. The method according to claim 7, wherein the solder is applied as a brazing paste.

13. The method according to claim 7, wherein the solder is applied onto the cover plate and/or the plate-like fiber layer
a) by spraying or dipping,
b) is applied as a foil onto the cover plate and/or the plate-like fiber layer, and/or
c) is applied and the fibers are solder-coated during manufacture of the plate-like fiber layer.

14. The method according to claim 7, wherein so much solder is present in a contact area between the cover plate and the plate-like fiber layer before heating that the solder passes through the plate-like fiber layer after melting.
